(19) United States
(12) Patent Application Publication
(10) Pub. No.: US 2022/0134786 A1
(43) Pub. Date: May 5, 2022

(54) RECORDING DEVICE

(71) Applicant: SEIKO EPSON CORPORATION, Tokyo (JP)

(72) Inventor: Eiichi OHARA, Matsumoto, Nagano (JP)

(21) Appl. No.: 17/434,031

(22) PCT Filed: Dec. 16, 2019
(86) PCT No.: PCT/JP2019/049170

§ 371 Date: Aug. 26, 2021

(30) Foreign Application Priority Data
Feb. 28, 2019 (JP) 2019-035554

(51) Int. Cl. B41J 25/00

(52) U.S. Cl. CPC B41J 25/001

(57) ABSTRACT

A recording device includes a platen as a support portion configured to support a medium, a head configured to perform scanning relative to the platen in a main scanning direction and discharge a droplet onto the medium supported by the platen, and a spacing change unit provided in at least one of a first region and a second region that sandwich a recording region PA of the medium in the main scanning direction, wherein the spacing change unit is provided without overlapping the recording region PA when viewed from a direction perpendicular to a surface at which the platen supports the medium, and a first spacing is narrower than a second spacing, the first spacing being a spacing between the spacing change unit and the head, the second spacing being a spacing between the platen and the head in the recording region PA.

### TECHNICAL FIELD

The present disclosure relates to a recording device.

### BACKGROUND ART

Recently, a recording device has been known that records images, etc. by discharging droplets from a head toward a medium. In order to perform high-quality recording on such a recording device, it is necessary to set an appropriate spacing between the head and the medium. For example, Patent Literature 1 discloses a recording device capable of increasing and decreasing a platen gap, which is a spacing between the head and a platen that supports a recording member, depending on a thickness of a recording material as the medium.

### CITATION LIST

### Patent Literature

PTL 1: JP-A-2009-248535

### SUMMARY OF INVENTION

### Technical Problem

However, in the recording device in Patent Literature 1, a second spacing, which is the platen gap, is set with a certain margin in consideration of floating of the medium, etc. such that so-called head rubbing (the head comes into contact with the medium) does not occur. In this manner, when the second spacing with a margin is set, the influence of airflow generated between the head and the medium increases, which results in a problem in that the recording quality is reduced due to the variation in landing positions of the droplets discharged from the head.

### Solution to Problem

A recording device according to the present application includes a support portion configured to support a medium, a head configured to perform scanning relative to the support portion in a main scanning direction and discharge a droplet onto the medium supported by the support portion, and a spacing change unit provided in at least one of a first region and a second region that sandwich a recording region of the medium in the main scanning direction, wherein the spacing change unit is provided without overlapping the recording region when viewed from a direction perpendicular to a surface at which the support portion supports the medium, and a first spacing is narrower than a second spacing, the first spacing being a spacing between the spacing change unit and the head along a vertical direction, the second spacing being a spacing between the support portion and the head in the recording region.

In the above recording device, it is preferable that the spacing change unit is provided at both the first region and the second region.

In the above recording device, it is preferable that the first region is a region between the recording region and a maintenance region for performing maintenance of the head.

It is preferable that the above recording device includes a height adjustment unit configured to change a height of the spacing change unit and adjust the first spacing in accordance with the second spacing.

In the above recording device, it is preferable that the spacing change unit is configured to move along the main scanning direction.

It is preferable that the above recording device includes a position adjustment unit configured to adjust a position of the spacing change unit in the main scanning direction in accordance with information of the recording region included in recording data for recording on the medium.

### BRIEF DESCRIPTION OF DRAWINGS

FIG. 1 is a front view illustrating a schematic configuration of a recording device according to an exemplary embodiment.

FIG. 2 is a block diagram, illustrating the schematic configuration of the recording device.

FIG. 3 is a schematic view illustrating an example of an array of nozzles in a head.

FIG. 4 is an enlarged plan view illustrating a recording unit.

FIG. 5 is an enlarged side view illustrating the recording unit.

FIG. 6 is a diagram illustrating an image of a ruled line recorded in a medium.

FIG. 7 is a diagram illustrating landing positions of droplets.

FIG. 8 is a diagram illustrating the landing positions of the droplets.

FIG. 9 is a diagram illustrating the landing positions of the droplets.

FIG. 10 is a diagram illustrating the landing positions of the droplets.

FIG. 11 is a diagram illustrating the landing positions of the droplets.

FIG. 12 is a graph illustrating a relationship between a second spacing and a width of a vertical ruled line.

FIG. 13 is an enlarged side view illustrating a recording unit of a recording device according to Modification 1.

FIG. 14 is a diagram illustrating landing positions of droplets.

FIG. 15 is an enlarged side view illustrating a recording unit of a recording device according to Modification 2.

FIG. 16 is an enlarged plan view illustrating a recording unit of a recording device according to Modification 3.

FIG. 17 is an enlarged plan view illustrating a recording unit of a recording device according to Modification 4.

FIG. 18 is an enlarged plan view illustrating the recording unit of the recording device.

### DESCRIPTION OF EMBODIMENTS

With reference to the drawings, description is given below of an exemplary embodiment of the present disclosure. The following is one exemplary embodiment of the present disclosure and are not intended to limit the present disclosure. Note that the respective drawings may be illustrated not-to-scale, for illustrative clarity. Also, as for coordinates given in the drawings, it is assumed that both directions along a Z-axis correspond to an up/down direction where a +Z direction is an upward direction; both directions along an X-axis correspond to a front/rear direction where a −X direction is a frontward direction; both directions along a Y-axis correspond to a left/right direction where a +Y direction is a leftward direction; and an X-Y plane is a horizontal plane. In addition, a tip of the arrow indicating each axis is defined as a positive direction and a base end is defined as a negative direction. In addition, both directions along the X axis correspond to a main scanning direction, the Y axis corresponds to a sub scanning direction, and the Z axis corresponds to a vertical direction.

1. Exemplary Embodiment

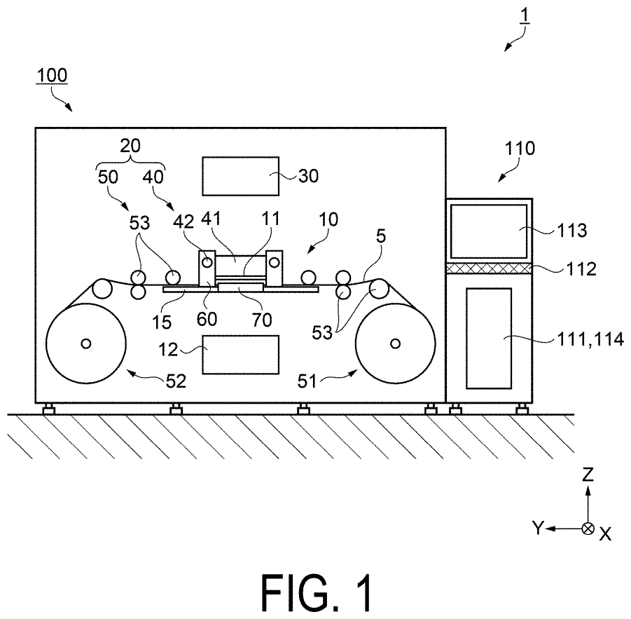

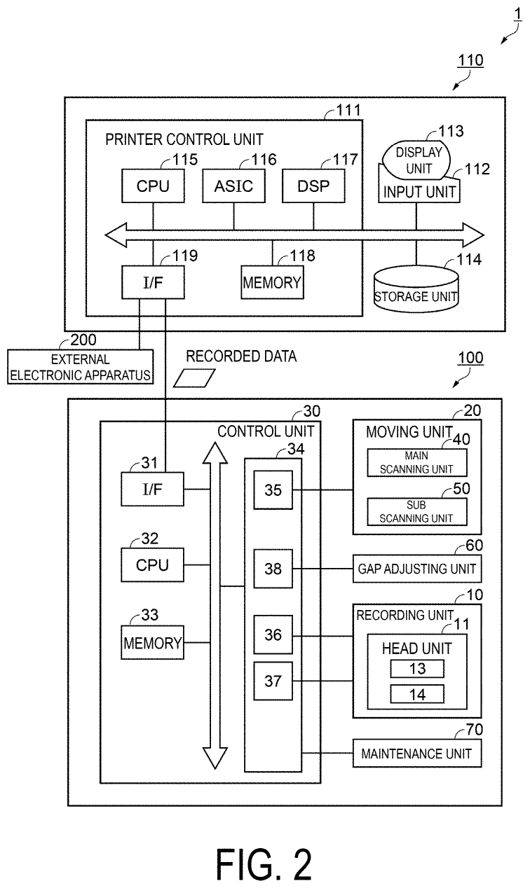

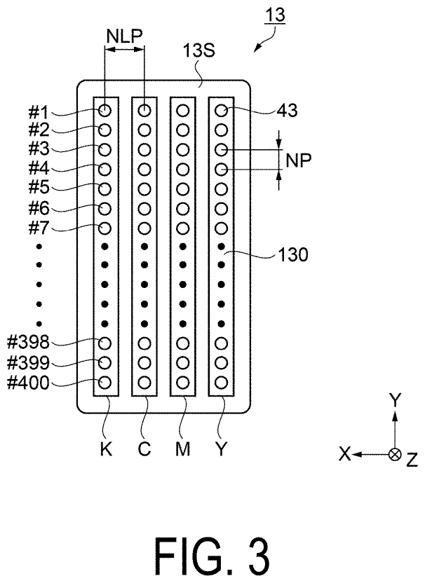

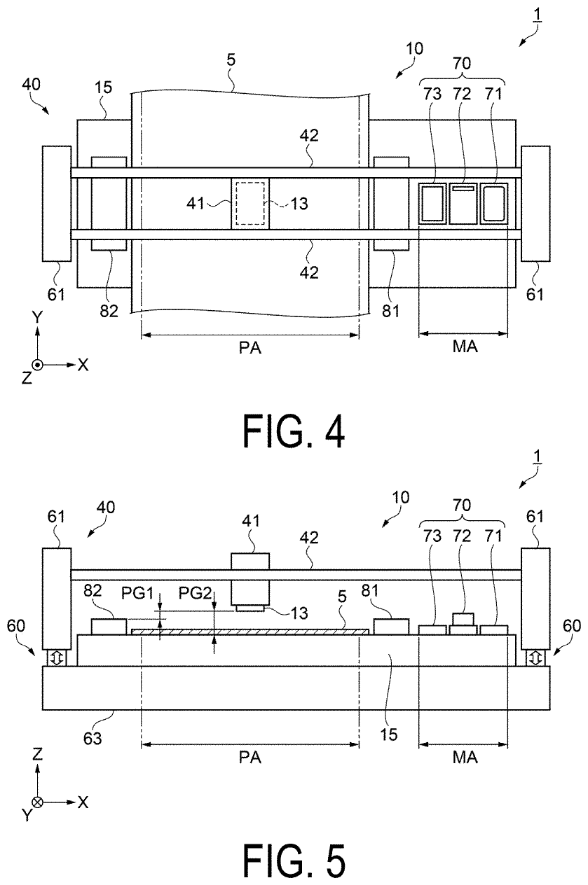

FIG. 1 is a front view illustrating a schematic configuration of a recording device 1 according to an exemplary embodiment. FIG. 2 is a block diagram illustrating the schematic configuration of the recording device 1. FIG. 3 is a schematic view illustrating an example of an array of nozzles in a head 13. FIG. 4 is an enlarged plan view illustrating a recording unit 10. FIG. 5 is an enlarged side view illustrating the recording unit 10. Note that FIG. 3 illustrates a state in which a nozzle surface 13S of a head 13 is viewed from below. FIG. 4 illustrates a state in which the recording unit 10 is viewed from above. FIG. 5 illustrates a state in which the recording unit 10 is viewed along the Y-axis.

First, the configuration of the recording device 1 will be described with reference to FIGS. 1 to 5.

The recording device 1 includes a printer 100, and an image processing apparatus 110 coupled to the printer 100. The printer 100 is an inkjet printer that records a desired image on a medium 5 having an elongated shape, which is supplied in a state of being wound into a roll, based on recording data received from the image processing apparatus 110.

The basic configuration of the image processing apparatus 110 will be described.

As illustrated in FIGS. 1 and 2, the image processing apparatus 110 includes a printer control unit 111, an input unit 112, a display unit 113, a storage unit 114, etc. The image processing apparatus 110 controls recording jobs to be recorded by the printer 100. In a preferred example, the image processing apparatus 110 is configured using a personal computer.

Software operated by the image processing apparatus 110 includes general image processing application software that handles image data to be recorded, and printer driver software that controls the printer 100 and generates recording data for the printer 100 to execute recording. Hereinafter, the image processing application software is referred to as an application, and the printer driver software is referred to as a printer driver. That is, the image processing apparatus 110 controls the printer 100 via the recording data for allowing the printer 100 to record a recording image based on the image data. Note that the printer driver is not limited to a configuration example as a functional unit using software but may also be configured using firmware, for example.

The printer control unit 111 includes a CPU (Central Processing Unit) 115, an ASIC (Application Specific Integrated Circuit) 116, a DSP (Digital Signal Processor) 117, a memory 118, an interface 119, etc. The printer control unit 111 and centrally manages the entire recording device 1.

The input unit 112 is an information input means serving as a human interface. Specifically, the input unit 112 is, for example, a port, etc. for coupling a keyboard, a mouse pointer, or an information input device.

The display unit 113 is an information display means serving as a human interface, and displays information inputted from the input unit 112, an image to be recorded by the printer 100, information related to a recording job, etc., based on the control of the printer control unit 111.

The storage unit 114 is a rewritable storage medium such as a hard disk drive (HDD) or a memory card, and stores software run by the image processing apparatus 110, an image to be recorded, information related to a recording job, etc.

The memory 118 is a storage medium that secures a region for storing programs run by the CPU 115, a work region in which such programs run, etc. The memory 118 includes storage elements such as a RAM and an EEPROM.

Next, the basic configuration of the printer 100 will be described.

The printer 100 includes a recording unit 10, a moving unit 20, a control unit 30, a gap adjusting unit 60, a maintenance unit 70, etc. Upon reception of the recording data from the image processing apparatus 110, the printer 100 controls the recording unit 10, the moving unit 20, and the gap adjustment unit 60 by the control unit 30, and then records an image on the medium 5.

The recording data is data for image formation obtained by converting the image data so that the image data can be recorded by the printer 100 using the application and the printer driver included in the image processing apparatus 110. The recording data includes a command for controlling the printer 100 and information of the medium 5 to be used. The image data includes, for example, general full color image information or text information obtained by a digital camera, etc.

The recording unit 10 includes a head unit 11, an ink supply unit 12, a platen 15 as a support portion for supporting the medium 5, etc.

As shown in FIGS. 2 and 3, the head unit 11 includes a head 13 and a head control unit 14. The head 13 includes a plurality of nozzles 43 for discharging ink, etc. as droplets and a nozzle surface 13S at which the nozzles 43 are arranged in a row. The head unit 11 is mounted on a carriage 41 and reciprocates with the carriage 41 moving in the main scanning direction. Under the control of the control unit 30 while the head unit 11 including the head 13 moves in the main scanning direction, a raster line is formed at the medium 5 by discharging droplets onto the medium 5 supported by the platen 15. The raster line corresponds to a row of dots along the main scanning direction.

The ink supply unit 12 includes an ink tank and an ink supply path for supplying ink from the ink tank to the head 13. The ink tank, the ink supply path, and an ink supply path to the nozzles for discharging the same ink are provided separately for each ink.

Examples of the ink include a four color ink set obtained by adding black (K) to a three color ink set including cyan (C), magenta (M), and yellow (Y), as an ink set of dark ink compositions. Examples of the ink also include an eight color ink set obtained by adding an ink set of light ink compositions, such as light cyan (Lc), light magenta (Lm), light yellow (Ly), and light black (Lk), with reduced concentrations of the respective color materials.

A piezo method is used as the method for discharging droplets. The piezo method is a method of recording by using a piezoelectric element to apply a pressure corresponding to a recording information signal to the ink stored in a pressure chamber, and thus discharging droplets from the nozzles 43 communicated with the pressure chamber. Note that the method of discharging droplets is not limited thereto, and any other recording method may be employed in which ink is jetted in the form of droplets to form dot groups on a recording medium. Examples of such a method may include a method of recording by continuously jetting ink in the form of droplets from nozzles by use of an intense electric field between the nozzles and an accelerating electrode provided in front of the nozzles, and by sending a recording information signal from a deflecting electrode while the droplets are in flight; a method (electrostatic suction method) in which the droplets are jetted, without being deflected, according to the recording information signal; a method in which the droplets are forcibly jetted by pressurizing ink with a small pump and mechanically vibrating the nozzles with a piezoelectric element, etc.; a method (thermal jet method) for recording by heating and foaming ink with a microelectrode according to a recording information signal and thus jetting the droplets; etc.

The moving unit 20 includes a main scanning unit 40, a sub scanning unit 50, etc, and moves the medium 5 and the head 13 relative to each other under the control of the control unit 30.

The main scanning unit 40 includes a carriage 41, a guide shaft 42, and a carriage motor (not illustrated). The guide shaft 42 extends in the scanning direction and supports the carriage 41 in a slidable state. The carriage motor serves as a driving source when reciprocating the carriage 41 along the guide shaft 42. Under the control of the control unit 30, the main scanning unit 40 performs main scanning operation of moving the carriage 41 along the guide shaft 42 in the main scanning direction, and moves the carriage 41 relative to the medium 5. This allows the head 13 to be scanned in the main scanning direction and discharge the droplets with respect to the overall width of the medium 5 supported by the platen 15.

The sub scanning unit 50 includes a supply unit 51, a housing unit 52, transport rollers 53, etc. The supply unit 51 rotatably supports a reel on which the medium 5 is wounded into a roll, and feeds the medium 5 into the transport path. The housing unit 52 rotatably supports the reel that rolls up the medium 5, and rolls up the medium 5 for which recording has been completed from the transport path. The transport rollers 53 include a driving roller that moves the medium 5 in the sub scanning direction that intersects the main scanning direction, a driven roller rotated along with the movement of the medium 5, etc. The transport rollers 53 constitute the transport path for transporting the medium 5 from the supply unit 51 to the housing unit 52 via the recording unit 10. In the recording region, under the control of the control unit 30, the sub scanning unit 50 performs sub scanning operation of moving the medium 5 in the sub scanning direction that intersects the main scanning direction, and moves the medium 5 relative to the head 13.

As illustrated in FIGS. 4 and 5, the maintenance unit 70 performs maintenance of the head 13, and is provided at one side of the medium 5 in the main scanning direction. The maintenance unit 70 is disposed at a position where the maintenance unit 70 overlaps with the head 13 that reciprocates along the main scanning direction in a plan view from the Z-axis. For example, the maintenance unit 70 includes a suction unit 71 that sucks ink in the nozzles 43 of the head 13, a wiping unit 72 having a flexible blade that removes ink adhered to the nozzle surface 13S, and a flushing unit 73 that discharges ink from the nozzles 43. Performing maintenance of the head 13 allows for restoring or preventing discharge failures.

The control unit 30 includes an interface 31, a CPU 32, a memory 33, a drive control unit 34, etc., and The control unit 30 controls the printer 100.

The interface 31 is coupled to the interface 119 of the image processing apparatus 110 to transmit and receive data between the image processing apparatus 110 and the printer 100. The image processing apparatus 110 and the printer 100 may be coupled directly with a cable, etc, or indirectly through a network, etc. Alternatively, the interface 31 may transmit and receive data between the image processing apparatus 110 and the printer 100 through wireless communication.

The CPU 32 is an arithmetic processing unit for overall control of the printer 100. The memory 33 is a storage medium that secures a region for storing programs run by the CPU 32, a work region in which such programs run, etc., and includes storage elements such as a RAM and an EEPROM. According to the program stored in the memory 33 and the recording data received from the image processing apparatus 110, the CPU 32 controls the recording unit 10 and the moving unit 20 through the drive control unit 34. The image data to be recorded can be acquired from an external electronic device 200 coupled to the interface 119.

The drive control unit 34 includes a moving control signal generation circuit 35, a discharge control signal generation circuit 36, a drive signal generation circuit 37, and a gap control circuit 38. Based on the control of the CPU 32, the drive control unit 34 controls operation of each unit of the printer 100, such as the recording unit 10, the moving unit 20, the gap adjustment unit 60, the maintenance unit 70, etc.

The moving control signal generation circuit 35 is a circuit that generates a signal for controlling the main scanning unit 40 and the sub scanning unit 50 of the moving unit 20 according to an instruction from the CPU 32.

The discharge control signal generation circuit 36 is a circuit that generates a head control signal for selecting nozzles that discharge ink, selecting a discharge amount, controlling the discharge timing, etc. according to an instruction from the CPU 32 based on the recording data.

The drive signal generation circuit 37 is a circuit that generates a basic drive signal including a drive signal that drives the piezoelectric element of the head 13.

The gap control circuit 38 is a circuit that generates a signal that controls the gap adjustment unit 60 according to an instruction from the CPU 32.

The drive control unit 34 selectively drives the piezoelectric elements corresponding to the respective nozzles based on the head control signal and the basic drive signal.

As shown in FIG. 3, the head 13 includes nozzle rows 130 formed by arranging a plurality of nozzles 43 for discharging each ink at a predetermined nozzle pitch NP. For example, the nozzle rows 130 includes #1 to #400 of the nozzles 43, and further includes a black ink nozzle row K, a cyan ink nozzle row C, a magenta ink nozzle row M, and a yellow ink nozzle row Y. The nozzle rows 130 are aligned and arranged so that the nozzle rows 130 are parallel to each other at a nozzle row pitch NLP along the main scanning direction that intersects the sub scanning direction. Further, each nozzle 43 is provided with a piezoelectric element for applying pressure to a pressure chamber communicating with each nozzle 43 to discharge droplets. A second spacing PG2 between the head 13 and the platen 15 is configured to be adjustable by the gap adjustment unit 60.

As illustrated in FIGS. 4 and 5, the gap adjustment unit 60 adjusts the second spacing PG2 between the platen 15 and the head 13. The gap adjustment unit 60 is provided between a base frame 63 that supports the platen 15 and two guide shaft support portions 61 that support both end portions of the guide shaft 42. The gap adjustment unit 60 includes a drive motor (not illustrated) controlled by a signal from the gap control circuit 38, and can move the guide shaft support portions 61 in the up/down direction along the Z axis by the driving of the drive motor. As a mechanism for moving the gap adjustment unit 60 in the up/down direction, for example, a mechanism that performs movement by rotating a cam, a mechanism combining a ball screw and a ball nut, a linear guide mechanism, etc. may be employed.

Next, the spacing change unit will be described.

As illustrated in FIG. 4 and FIG. 5, the spacing change unit is a member that, when the head 13 is scanned in the main scanning direction, changes a spacing between the head 13 and an outer side of a recording region PA of the medium 5. In the main scanning direction, the spacing change unit is provided in at least one of a first region between the recording region PA of the medium 5 and a maintenance region MA at which the maintenance unit 70 is disposed, and a second region at a position opposite the first region through the recording region PA. In the present exemplary embodiment, a configuration is illustrated in which the spacing change unit includes a first spacing change unit 81 (a spacing change unit in the first region) and a second spacing change unit 82 (a spacing change unit in the second region). That is, the first spacing change unit 81 and the second spacing change unit 82 are provided at the outer side of the recording region PA in the main scanning direction.

The first spacing change unit 81 and the second spacing change unit 82 are provided at the platen 15, and are disposed at positions where the first spacing change unit 81 and the second spacing change unit 82 overlap with the head 13 that reciprocates along the main scanning direction in a plan view from the Z-axis. Further, the first spacing change unit 81 and the second spacing change unit 82 are provided such that the first spacing change unit 81 and the second spacing change unit 82 do not overlap with the recording region PA when viewed from a direction perpendicular to a surface at which the platen 15 supports the medium 5, that is, in a plan view from the Z-axis. The first spacing change unit 81 and the second spacing change unit 82 form a rectangular shape having a length in the sub scanning direction equal to or longer than the length of the head 13, and the heights thereof are higher than the thickness of the medium 5 and lower than the nozzle surface 13S of the head 13. That is, a first spacing PG1 between the first spacing change unit 81 and the second spacing change unit 82, and the head 13 along the Z-axis, is narrower than a second spacing PG2 between the platen 15 and the head 13.

According to the configuration described above, the control unit 30 performs recording of a desired image on the medium 5 by repeating the main scanning operation and the sub scanning operation with respect to the medium 5 supplied to the recording unit 10 by the sub scanning unit 50. The main scanning operation discharges droplets from the head 13 while moving the carriage 41 supporting the head 13 in the main scanning direction. The sub scanning operation moves the medium 5 in the sub scanning direction that intersects the main scanning direction by the sub scanning unit 50.

Note that in the present exemplary embodiment, an example is illustrated in which the recording device 1 includes the image processing device 110 and the printer 100, while the printer may be configured to include functions of the image processing device.

Further, in the present exemplary embodiment, as an example of the printer, the configuration has been described as an example in which the medium 5 having an elongated shape is supplied by the roll method, while no such limitation is intended. For example, the printer may have a single-sheet configuration in which short sheet paper cut to a predetermined length is supplied.

Next, an influence of airflow generated between the head 13 and the platen 15 will be described.

The control unit 30 sets the second spacing PG2 between the head 13 and the platen 15 in accordance with the thickness and material of the medium 5. When a material that easily floats from the platen 15 is used for the medium 5, for the purpose of avoiding head rubbing in which the medium 5 comes into contact with the head 13, the second spacing PG2 is set to a larger spacing than the case where a material that does not easily float is used for the medium 5. As the second spacing PG2 is set to a larger spacing and the space between the head 13 and the medium 5 further expands, the variation in landing positions of the droplets discharged by the head 13 tends to increase, whereby the recording quality may decrease. It has been found that one of the factors that increase the variation in the landing positions is that the movement of the head 13 in the main scanning direction affects the airflow generated between the nozzle surface 13S of the head 13 and the medium 5. The airflow occurs in the main scanning movement of the head 13. The droplets discharged by reversing the movement direction of the head 13 are affected by the remaining air flow.

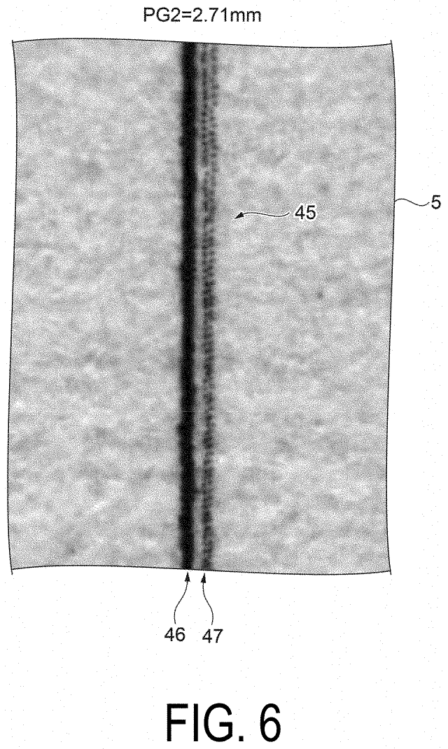

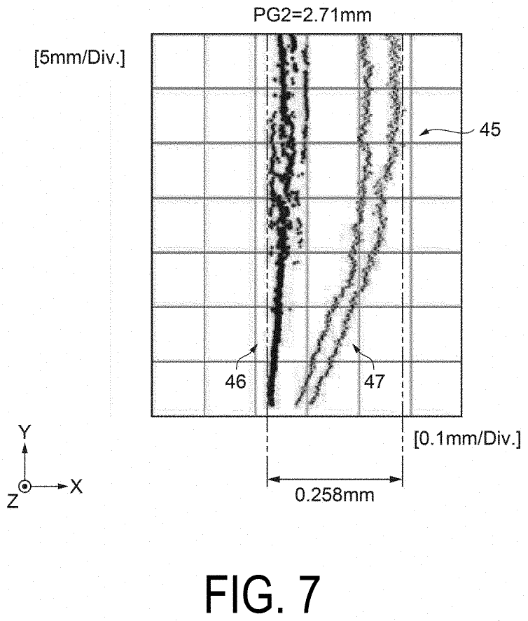

FIG. 6 is a diagram illustrating an image of a ruled line recorded in the medium 5. FIGS. 7 to 11 are diagrams illustrating the landing positions of the droplets. Note that a vertical axis in FIGS. 7 to 11 represents 5 mm per graduation, and a horizontal axis represents 0.1 mm per scale.

In the diagrams illustrated in FIGS. 6 to 11, in order to evaluate the influence of this airflow, the head 13 is once moved for main scanning in the +X direction so as to pass through the recording region PA. Then the movement direction is reversed in the −X direction, and immediately after the head 13 enters the recording region PA, one shot of K ink droplets is simultaneously discharged from all the nozzles to record a vertical ruled line 45.

An initial speed of the droplets is set relatively high in order to discharge a very small amount of droplets from the nozzles 43 and ensure that they land on the medium 5. Thus, the droplets discharged from the nozzles 43 are stretched during flight to separate into the main droplets 46 and the satellite droplets 47 having a smaller mass than the main droplets 46. The satellite liquid droplets 47 land on the medium 5 following the main droplets 46.

FIGS. 6 and 7 illustrate the results of recording the vertical ruled line in a recording device in which the first and second spacing change units 81, 82 are not provided, that is, the recording device of the known art. Note that the second spacing PG2 between the head 13 and the platen 15 is set to 2.71 mm. In the main scanning direction, the satellite droplets 47 are easily affected by the airflow due to the small mass of the droplets. The satellite droplets 47 are affected by the airflow in the +X direction caused by the head 13 that has moved in the +X direction prior to the discharge. The satellite droplets 47 are landed in the +X direction from the landing positions of the main droplets 46. As shown in FIG. 6, this shift in the landing positions causes deterioration of recording quality, for example, the vertical ruled line 45 becomes two lines or the width thereof becomes thick and blurry. As illustrated in FIG. 7, the shift of the landing positions, that is, the width of the vertical ruled line 45 was 0.258 mm. This shift of the landing positions increases as the second spacing PG2 increases.

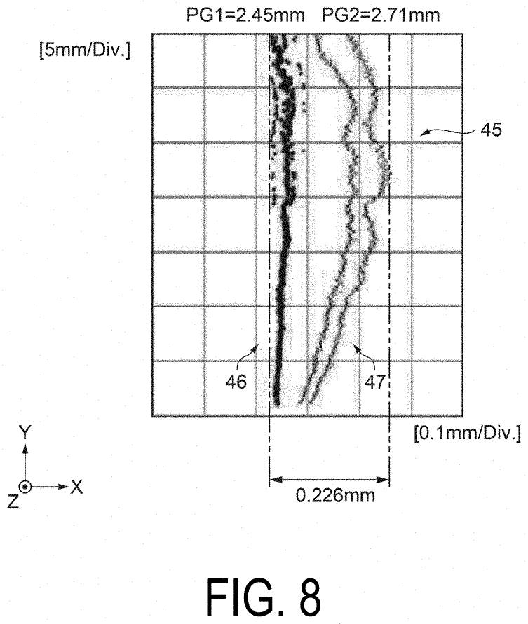

FIGS. 8 to 11 illustrate the results of recording the vertical ruled line 45 with the first spacing PG1 as a parameter. The first spacing PG1 is a spacing between the first and second spacing change units 81, 82, and the head 13. The first and second spacing change units 81, 82 are spacing change units. Note that the length in the main scanning direction of the first and second spacing change units 81, 82 is 60 mm, which is longer than the length in the main scanning direction of the head 13. The second spacing PG2 is fixed to 2.71 mm.

FIG. 8 illustrates the shift of the landing positions when the first spacing PG1 is set to 2.45 mm. The width of the vertical ruled line 45 recorded under this condition was 0.226 mm.

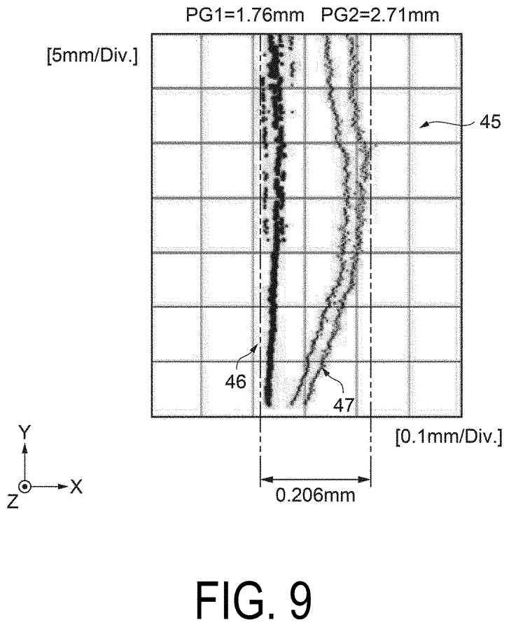

FIG. 9 illustrates the shift of the landing positions when the first spacing PG1 is set to 1.76 mm. The width of the vertical ruled line 45 recorded under this condition was 0.206 mm.

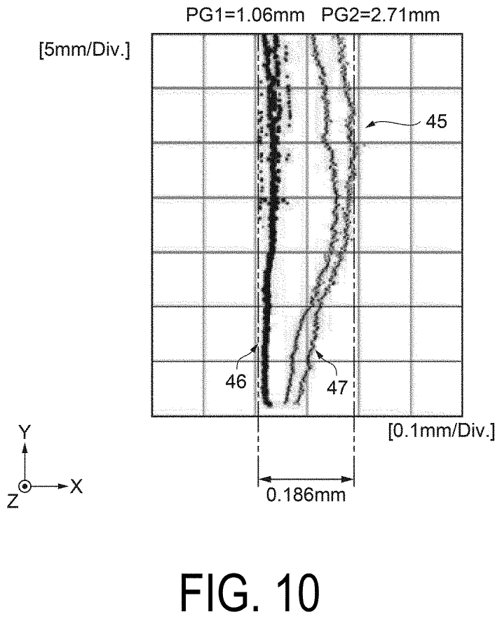

FIG. 10 illustrates the shift of the landing positions when the first spacing PG1 is set to 1.06 mm. The width of the vertical ruled line 45 recorded under this condition was 0.186 mm.

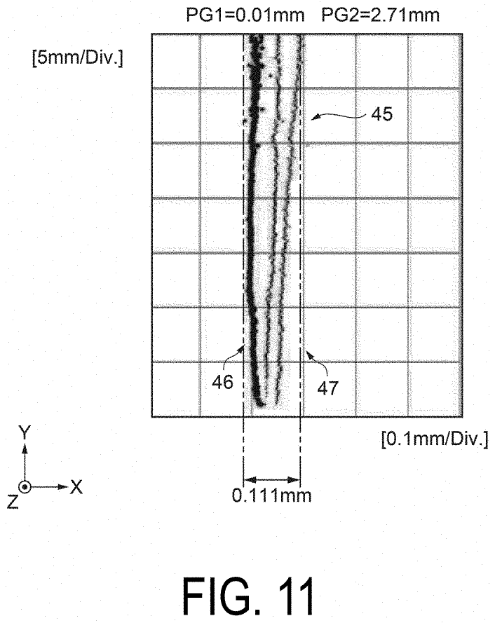

FIG. 11 illustrates the shift of the landing positions when the first spacing PG1 is set to 0.01 mm. The width of the vertical ruled line 45 recorded under this condition was 0.111 mm.

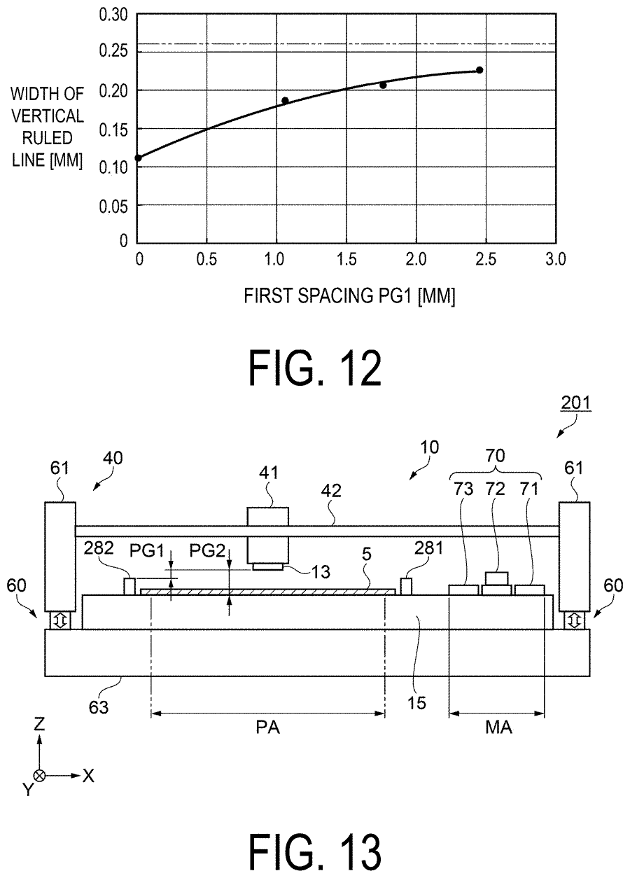

FIG. 12 is a graph illustrating a relationship between the second spacing PG2 and a width of a vertical ruled line 45. The vertical axis in FIG. 12 represents the width of the vertical ruled line 45, and the horizontal axis represents the first spacing PG1. Note that the straight line indicated by a two-dot chain line in the diagram is indicated by reference to the width of the vertical ruled line 45 when recorded in a recording device of the known art, in which the first and second spacing change units 81, 82 are not provided.

As described above, the width when the vertical ruled line 45 is recorded in the recording device of the known art is 0.258 mm. As illustrated in FIG. 12, in a case where the vertical ruled line 45 is recorded in the recording device 1 provided with the first and second spacing change units 81, 82, the width of the vertical ruled line 45 is recorded narrower than that of the known art at all points. This means that, by providing the first and second spacing change units 81, 82 serving as the spacing change units, the airflow generated by the previous main scanning operation is suppressed by the first and second spacing change units 81, 82, then the shift of the landing positions between the main droplets 46 and the satellite liquid droplets 47 is reduced, whereby the recording quality is improved. Furthermore, as the first spacing PG1 is narrowed, the width of the vertical ruled line 45 is recorded to be narrow, so that it is preferable to provide the first and second spacing change units 81, 82 as high as possible, within a range that the units do not contact the head 13.

In the present exemplary embodiment, a configuration is illustrated in which the first spacing change unit 81 and the second spacing change unit 82 are provided as the spacing change units. In this configuration, the recording quality can be improved in both bi-directional recording and unidirectional recording. Note that a configuration may be adopted in which one of the first spacing change unit 81 and the second spacing change unit 82 is provided as the spacing change unit. In this configuration, the recording quality can be improved in the unidirectional recording.

As described above, according to the recording device 1 of the present exemplary embodiment, the following advantages can be obtained.

The recording device 1 includes the first spacing change unit 81 and the second spacing change unit 82 at the outer side of the recording region PA in the main scanning direction. The first spacing PG1 between the first spacing change unit 81 and the second spacing change unit 82, and the head 13, is narrower than the second spacing PG2 between the platen 15 and the head 13. As a result, the influence of the airflow generated between the head 13 and the medium 5 is reduced, whereby the variation in the landing positions of the droplets discharged from the head 13 is reduced. Therefore, even when the second spacing PG2 is set in consideration of the floating of the medium 5, the recording quality can be improved.

Note that, the present disclosure is not limited to the exemplary embodiment described above, and various modifications and improvements can be added to the above-described exemplary embodiment. Modifications are described below.

2. Modification 1

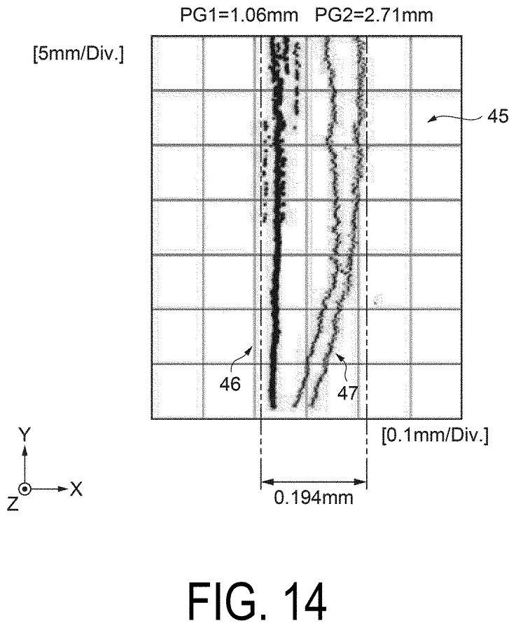

FIG. 13 is an enlarged side view illustrating a recording unit 10 of a recording device 201 according to Modification 1. FIG. 14 is a diagram illustrating landing positions of droplets. Next, the configuration of the recording device 201 according to Modification 1 will be described. Further, the same constituents as those in the exemplary embodiment are given the same reference signs, and redundant description of these constituents will be omitted.

The recording device 201 includes an spacing change unit. The spacing change unit is provided with a first spacing change unit 281 and a second spacing change unit 282 in the first region and the second region that sandwich the recording region PA in the main scanning direction.

The first spacing change unit 281 and the second spacing change 282 are provided at the platen 15, and are disposed at positions where the first spacing change unit 281 and the second spacing change 282 overlap with the head 13 that reciprocates along the main scanning direction in a plan view from the Z-axis. The first spacing change unit 281 and the second spacing change unit 282 form a rectangular shape having a length in the sub scanning direction equal to or longer than the length of the head 13, and the heights thereof are higher than the thickness of the medium 5 and lower than the nozzle surface 13S of the head 13.

The length in the main scanning direction of the first and second spacing change units 281, 282 is 8 mm, which is shorter than the length of the head 13. Additionally, the first spacing PG1 is 1.06 mm, and the second spacing PG2 is 2.71 mm. FIG. 14 illustrates the results of recording the vertical ruled line 45 in the same manner as in the exemplary embodiment using the first and second spacing change units 281, 282. The width of the vertical ruled line 45 recorded under this condition is 0.194 mm, and the width of the vertical ruled line recorded in the recording device of the known art is narrower than 0.258 mm, whereby the shift of the landing positions between the main droplets 46 and the satellite droplets 47 is reduced. Accordingly, even in a case where the first and second spacing change units 281, 282 having the length in the main scanning direction that is shorter than the length of the head 13, the recording quality can be improved.

3. Modification 2

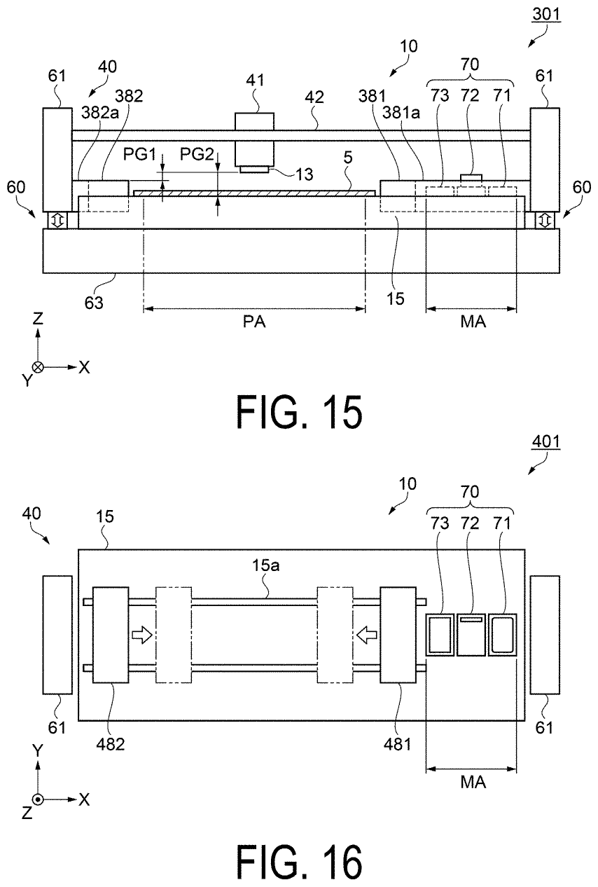

FIG. 15 is an enlarged side view illustrating a recording unit 10 of a recording device 301 according to Modification 2. The configuration of the recording device 301 according to Modification 2 will be described. Further, the same constituents as those in the exemplary embodiment are given the same reference signs, and redundant description of these constituents will be omitted.

The recording device 301 includes an spacing change unit. The spacing change unit is provided with a first spacing change unit 381 and a second spacing change unit 382 in the first region and the second region that sandwich the recording region PA in the main scanning direction.

The first spacing change unit 381 and the second spacing change unit 382 are provided so as to rise from within the platen 15, and are disposed at positions where the first spacing change unit 381 and the second spacing change unit 382 overlap with the head 13 that reciprocates along the main scanning direction in a plan view from the Z-axis. The first spacing change unit 381 and the second spacing change unit 382 form a rectangular shape having a length in the sub scanning direction equal to or longer than the length of the head 13, and the heights thereof are higher than the thickness of the medium 5 and lower than the nozzle surface 13S of the head 13.

The first spacing change unit 381 is coupled to one guide shaft support portion 61 by a first connecting portion 381a. The second spacing change unit 382 is coupled to the other guide shaft support portion 61 by a second connecting portion 382a. In other words, the first spacing change unit 381 and the second spacing change unit 382 are supported by the guide shaft support portions 61. As a result, the first spacing change unit 381 and the second spacing change unit 382 are movable in the up/down direction with the guide shaft 42 by the gap adjustment unit 60.

The control unit 30 drives the gap adjustment unit 60 in accordance with the medium 5 to be used, and adjusts the second spacing PG2 between the head 13 and the platen 15. At the same time, the heights of the first spacing change unit 381 and the second spacing change unit 382 are adjusted. In other words, the gap adjustment unit 60 functions as a height adjustment unit that changes the heights of the first spacing change unit 381 and the second spacing change unit 382 in accordance with the second spacing PG2, and adjusts the first spacing PG1. Thus, even in a case where the second spacing PG2 is changed in accordance with the medium 5 to be used, the first spacing PG1 between the first spacing change unit 381 and the second spacing change unit 382, and the head 13, can be maintained at a constant spacing.

4. Modification 3

FIG. 16 is an enlarged plan view illustrating a recording unit 10 of a recording device 401 according to Modification 3. The configuration of the recording device 401 according to Modification 3 will be described. Note that in FIG. 16, for convenience of explanation, the guide shaft 42, the carriage 41, the head 13, and the medium 5 are omitted. Furthermore, the same constituents as those in the exemplary embodiment are given the same reference signs, and redundant description of these constituents will be omitted.

The recording device 401 includes an spacing change unit. The spacing change unit is provided with a first spacing change unit 481 and a second spacing change unit 482 in the first region and the second region that sandwich the recording region PA (see FIG. 5) in the main scanning direction.

The first spacing change unit 481 and the second spacing change unit 482 are provided at the platen 15, and are disposed at positions where the first spacing change unit 481 and the second spacing change unit 482 overlap with the head 13 that reciprocates along the main scanning direction in a plan view from the Z-axis. The first spacing change unit 481 and the second spacing change unit 482 form a rectangular shape having a length in the sub scanning direction equal to or longer than the length of the head 13, and the heights thereof are higher than the thickness of the medium 5 and lower than the nozzle surface 13S of the head 13.

Two grooves 15a extending along the main scanning direction are provided at the platen 15. The first spacing change unit 481 and the second spacing change unit 482 include engagement units (not illustrated) that slidably engage with the grooves 15a. That is, the first spacing change unit 481 and the second spacing, change unit 482 are configured to be movable along the main scanning direction. As a result, even in a case where a medium having a different width in the main scanning direction is used as the medium 5, the first spacing change unit 481 and the second spacing change unit 482 can be installed in suitable positions.

The positions of the first spacing change unit 481 and the second spacing change unit 482 in the main scanning direction may be manually changed by the operator. Additionally, the positions of the first spacing change unit 481 and the second spacing change unit 482 in the main scanning direction may be automatically changed according to the width of the medium 5 used by the control unit 30. As a moving mechanism for moving the first spacing change unit 481 and the second spacing change unit 482, a mechanism including a combination of a ball screw and a ball nut, a linear guide mechanism, etc. may be employed.

5. Modification 4

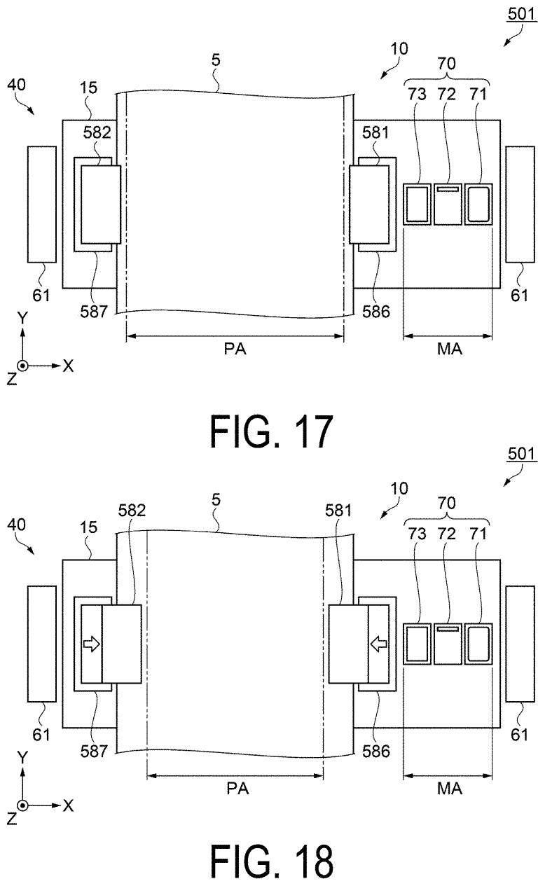

FIGS. 17 and 18 are enlarged plan views illustrating a recording unit 10 of a recording device 501 according to Modification 4. The configuration of the recording device 501 according to Modification 4 will be described. Note that in FIGS. 17 and 18, for convenience of explanation, the guide shaft 42, the carriage 41, and the head 13 are omitted. Furthermore, the same constituents as those in the exemplary embodiment are given the same reference signs, and redundant description of these constituents will be omitted.

The recording device 501 includes an spacing change unit. The spacing change unit is provided with a first spacing change unit 581 and a second spacing change unit 582 in the first region and the second region that sandwich the recording region PA in the main scanning direction.

The first spacing change unit 581 is provided at the platen 15 via a first position adjustment unit 586 as a position adjustment unit that adjusts a position of the first spacing change unit 581 in the main scanning direction. The second spacing change unit 582 is provided at the platen 15 via a second position adjustment unit 587 as a position adjustment unit that adjusts a position of the second spacing change unit 582 in the main scanning direction. The first spacing change unit 581 and the second spacing change unit 582 are disposed at positions where the first spacing change unit 581 and the second spacing change unit 582 overlap with the head 13 that reciprocates along the main scanning direction in a plan view from the Z-axis. The first spacing change unit 581 and the second spacing change unit 582 form a rectangular shape having a length in the sub scanning direction equal to or longer than the length of the head 13. The height of the position adjustment units 586, 587 is higher than the thickness of the medium 5, and the height of the top surfaces of the first spacing change unit 581 and the second spacing change unit 582 is lower than the nozzle surface 13S of the head 13.

The first position adjustment unit 586 includes a movement mechanism that supports the first spacing change unit 581 and slides the first spacing change unit 581 in a negative direction along the X axis. The second position adjustment unit 587 includes a movement mechanism that supports the second spacing change unit 582 and slides the second spacing change unit 582 in a positive direction along the X axis. As a moving mechanism for sliding the first spacing change unit 581 and the second spacing change unit 582, a mechanism including a combination of a ball screw and a ball nut, a linear guide mechanism, etc. may be employed.

The control unit 30 drives the movement mechanisms of the first position adjustment unit 586 and the second position adjustment unit 587 in accordance with the information of the recording region PA of the medium 5 included in the recording data received from the image processing device 110. The control unit 30 adjusts the positions in the main scanning direction of the first spacing change unit 581 and the second spacing change unit 582. FIG. 17 illustrates a position of the first spacing change unit 581 adjusted by the first position adjustment unit 586 and a position of the second spacing change unit 582 adjusted by the second position adjustment unit 587, when the recording region PA is wide with respect to the width of the medium 5. FIG. 18 illustrates a position of the first spacing change unit 581 adjusted by the first position adjustment unit 586 and a position of the second spacing change unit 582 adjusted by the second position adjustment unit 587, when the recording region PA is narrow with respect to the width of the medium 5. As illustrated in FIG. 18, the first spacing change unit 581 and the second spacing change unit 582 slide in alignment with the position of the recording region PA, and covers the excess of the medium 5 outside the recording region PA. As a result, even in a case where the width of the recording region PA increases or decreases with respect to the width of the medium 5, the first spacing change unit 581 and the second spacing change unit 582 can be installed in suitable positions. Additionally, the spacing between the first spacing change unit 581 and the second spacing change unit 582 in the main scanning direction becomes narrower, and the distance that the head 13 is moved is shortened, whereby the recording speed can be improved.

Contents derived from the exemplary embodiment will be described below.

A recording device includes a support portion configured to support a medium, a head configured to perform scanning relative to the support portion in a main scanning direction and discharge a droplet onto the medium supported by the support portion, and a spacing change unit provided in at least one of a first region and a second region that sandwich a recording region of the medium in the main scanning direction, wherein the spacing change unit is provided without overlapping the recording region when viewed from a direction perpendicular to a surface at which the support portion supports the medium, and a first spacing is narrower than a second spacing, the first spacing being a spacing between the spacing change unit and the head along a vertical direction, the second spacing being a spacing between the support portion and the head in the recording region.

According to this configuration, the recording device includes the spacing change unit that adjusts a spacing between the head and the medium. The inventors of the present application found that, by providing a spacing change unit at the outer side of the recording region in the main scanning direction and making the first spacing between the spacing change unit and the head be narrower than the second spacing between the support portion and the head in the recording region, the effect of the airflow generated between the head and the medium decreases, whereby the variation in the landing positions of droplets discharged from the head decreases. As a result, even when a second spacing is set in consideration of floating of a medium, the recording quality can be improved.

In the above recording device, it is preferable that the spacing change unit is provided at both the first region and the second region.

According to this configuration, the recording quality can be improved in both the bi-directional recording and the unidirectional recording.

In the above recording device, it is preferable that the first region is a region between the recording region and a maintenance region for performing maintenance of the head.

According to this configuration, the recording quality can be improved while taking advantage of the dead space between the recording region and the maintenance region.

It is preferable that the above recording device includes a height adjustment unit configured to change a height of the spacing change unit and adjust the first spacing in accordance with the second spacing.

According to this configuration, even in a case where the second spacing is changed, the first spacing between the spacing change unit and the head can be maintained at a constant spacing.

In the above recording device, it is preferable that the spacing change unit is configured to move along the main scanning direction.

According to this configuration, even in a case where a medium having a different width in the main scanning direction is used, the spacing change unit can be installed at a suitable position.

It is preferable that the above recording device includes a position adjustment unit configured to adjust a position of the spacing change unit in the main scanning direction in accordance with information of the recording region included in recording data for recording on the medium.

According to this configuration, even in a case where the width of the recording region in the medium increases or decreases, the spacing change unit can be installed at a suitable position.

### REFERENCE SIGNS LIST

1, 201, 301, 401, 501 . . . Recording device, 5 . . . Medium, 10 . . . Recording unit, 11 . . . Head unit, 12 . . . Ink supply unit, 13 . . . Head, 15 . . . Platen as support portion, 15a . . . Groove, 20 . . . Moving unit, 30 . . . Control unit, 40 . . . Main scanning unit, 42 . . . Guide shaft, 45 . . . Vertical ruled line, 46 . . . Main droplet, 47 . . . Satellite droplet, 50 . . . Sub scanning unit, 51 . . . Supply unit, 52 . . . Housing unit, 60 . . . Gap adjustment unit, 70 . . . Maintenance unit, 81, 281, 381, 481, 581 . . . First spacing change unit, 82, 282, 382, 482, 582 . . . Second spacing change unit, 100 . . . Printer, 110 . . . Image processing apparatus, 200 . . . External electronic apparatus, 586 . . . First position adjustment unit, 587 . . . Second position adjustment unit, MA . . . Maintenance region, PA . . . Recording region, PG1 . . . First spacing, PG2 . . . Second spacing

1. A recording device comprising:
a support portion configured to support a medium;
a head configured to perform scanning relative to the support portion in a main scanning direction and discharge a droplet onto the medium supported by the support portion; and
a spacing change unit provided in at least one of a first region and a second region that sandwich a recording region of the medium in the main scanning direction, wherein
the spacing change unit is provided without overlapping the recording region when viewed from a direction perpendicular to a surface at which the support portion supports the medium, and
a first spacing is narrower than a second spacing, the first spacing being a spacing between the spacing change unit and the head along a vertical direction, the second spacing being a spacing between the support portion and the head in the recording region.

2. The recording device according to claim 1, wherein
the spacing change unit is provided in both the first region and the second region.

3. The recording device according to claim 1, wherein
the first region is a region between the recording region and a maintenance region for performing maintenance of the head.

4. The recording device according to claim 1, further comprising a height adjustment unit configured to change a height of the spacing change unit and adjust the first spacing in accordance with the second spacing.

5. The recording device according to claim 1, wherein
the spacing change unit is configured to move along the main scanning direction.

6. The recording device according to claim 1, further comprising a position adjustment unit configured to adjust a position of the spacing change unit in the main scanning direction in accordance with information of the recording region included in recording data for recording on the medium.
